(19) United States
(12) Patent Application Publication
(10) Pub. No.: US 2025/0266736 A1
(43) Pub. Date: Aug. 21, 2025

(54) COOLING MECHANISM FOR DRIVING MOTOR

(71) Applicant: HYUNDAI MOBIS CO., LTD., Seoul (KR)

(72) Inventors: Hae Jun YANG, Yongin-si (KR); Sang Jin KIM, Yongin-si (KR)

(73) Assignee: HYUNDAI MOBIS CO., LTD., Seoul (KR)

(21) Appl. No.: 19/058,605

(22) Filed: Feb. 20, 2025

(30) Foreign Application Priority Data
Feb. 21, 2024 (KR) 10-2024-0025178

(51) Int. Cl. H02K 5/20; H02K 1/16

(52) U.S. Cl. CPC H02K 5/203; H02K 1/16

(57) ABSTRACT

Provided is a driving motor having a cooling mechanism for directly cooling the driving motor by using cooling oil, and more particularly, a cooling mechanism for a driving motor that sprays the cooling oil onto a stator by using a snap ring to secure the stator to a motor housing.

### CROSS-REFERENCE TO RELATED APPLICATIONS

This application claims priority under 35 U.S.C. § 119 to Korean Patent Application No. 10-2024-0025178, filed on Feb. 21, 2024, in the Korean Intellectual Property Office, the disclosure of which is incorporated herein by reference in its entirety.

### TECHNICAL FIELD

The following disclosure relates to a driving motor having a cooling mechanism for directly cooling the driving motor by using cooling oil, and more particularly, to a cooling mechanism for a driving motor that sprays the cooling oil onto a stator by using a snap ring to secure the stator to a motor housing.

### BACKGROUND

A driving motor applied to an electric vehicle (EV) or a hybrid vehicle (HEV) may improve fuel efficiency from a vehicle perspective if the motor has higher output while having the same weight and size. However, in order for the driving motor to have the higher output, a current, that is, the input, may be required to be increased. However, if the current flows through a coil inside the motor, heat may occur due to coil resistance. Therefore, it is necessary to lower heat occurring in the driving motor.

Methods for cooling the coil inside the driving motor may be broadly classified into three types. A first method may be an air cooling method of using a cooling fin exposed to the outside, and a second method may be a water cooling method of indirectly cooling the coil by forming a water path in a housing or the like. A third method may be an oil-cooling method of using oil, which is an insulating material, to directly cool the coil inside the motor.

Recently, the number of cases applying a driving motor that uses a direct cooling method of using the cooling oil has increased in accordance with the continuously increasing demand for a high-efficiency and high-output driving motor for the development of a high-performance electric vehicle.

There are two types of methods for directly cooling the inside of the motor. One method is a churning-type that injects an appropriate amount of oil into the motor and pumps the oil by using a rotating body, and the other method is a spray-type that flows or sprays the oil from the top to the bottom.

As shown in FIG. 1, the spray-type may supply the oil to a cooling oil pipe 11 in order to intensively spray the cooling oil onto a stator assembly 10, and form an oil spray hole 13 at an end of the pipe 11 to spray the oil onto a target. The sprayed oil may flow through a coil 15 of the stator assembly 10. In this case, the sprayed oil may fall downwards because the oil flows by gravity under a condition where the motor is mounted on the vehicle.

Meanwhile, the stator assembly 10 of the driving motor may have a circular shape, and the oil sprayed from the top may thus flow only downwards, staying adjacent to the spray hole 13, thus limiting a cooling range.

To improve this limitation/problem, a conventional technology has been publicly disclosed to include an oil guide to spray the oil by dividing the oil into several paths, thus allowing the oil flowing into the oil guide to be evenly sprayed onto the stator assembly 10.

A conventional cooling structure of the driving motor including the oil guide as described above may further include the oil guide configuration, which acts as resistance to an oil flow, thus causing an insufficient effect on increasing cooling efficiency, and may require additional processes for manufacturing and assembling the oil guide, thereby increasing both its manufacturing cost and process cost.

### SUMMARY

An embodiment of the present disclosure is directed to providing a cooling mechanism for a driving motor, in which an oil path and a spray hole are formed in a snap ring for securing a stator inserted into a motor housing, and an oil supply groove is formed between the motor housing and the stator for an end of the groove to communicate with the oil path of the snap ring, thereby supplying cooling oil to the stator by using the snap ring.

In one general aspect, provided is a cooling mechanism for a driving motor, the mechanism including: a cylindrical stator wound with a coil; a cylindrical motor housing having one side sealed, the other side open, and accommodating the stator; a snap ring fitted into an inner circumferential surface of the other side of the motor housing to have a radial inner side protruding inward from the inner circumferential surface of the motor housing, and securing the other side of the stator by having one surface protruding and in contact with a circumference of the other surface of the stator; and an oil supply path formed between an outer circumferential surface of the stator and the inner circumferential surface of the motor housing to supply oil to the snap ring, wherein the snap ring includes an oil spray path having an upstream side fluidically communicating with the oil supply path and a downstream side passing through an inner circumferential surface of the snap ring and exposed to the other side of the stator.

The oil supply path may be formed in an axial direction, have a predetermined width in a circumferential direction, and be recessed radially inward from the outer circumferential surface of the stator.

The oil supply path may be formed in an axial direction, have a predetermined width in a circumferential direction, and be recessed radially outward from the inner circumferential surface of the motor housing.

The oil spray path may include an inflow path recessed circumferentially upward from a lower surface of the snap ring, an outflow path passing through the snap ring radially inward from the other end of the inflow path, and a spray hole formed in a downstream end of the outflow path.

The inflow path may be formed in a closed curve in a circumferential direction, or the one or more inflow paths may each have a predetermined width in the circumferential direction and be disposed to be spaced apart from each other in the circumferential direction.

The oil spray path may include an outflow path recessed upward from a radially inner lower surface of the snap ring, and a spray hole formed in a radially inner end of the outflow path.

The plurality of outflow paths may have equal spacing in a circumferential direction or have variable spacing based on a region of the stator, where heat occurs.

The outflow path may have an upstream end fluidically communicating with the inflow path, have a predetermined width in a circumferential direction, and be recessed upward from the lower surface of the snap ring.

The outflow path may have a longer recessed length toward its radial inner side.

The outflow path may have a smaller circumferential width toward its radial inner side.

Other features and aspects will be apparent from the following detailed description, the drawings, and the claims.

### BRIEF DESCRIPTION OF THE DRAWINGS

FIG. 1 is a view showing the inside of a driving motor using a spray cooling method.

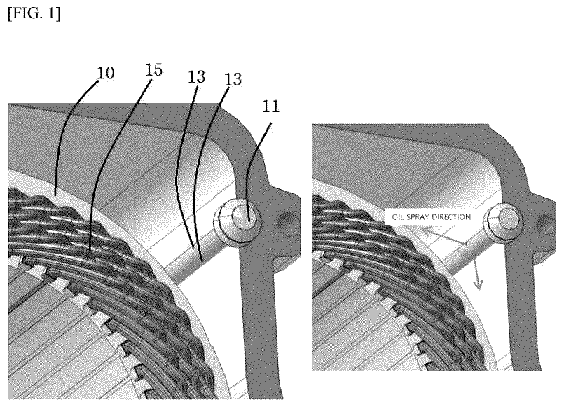

FIG. 2 is a partial cross-sectional perspective view of a driving motor having a cooling mechanism for a driving motor according to an embodiment of the present disclosure.

FIG. 3 is a partial enlarged perspective view showing a snap ring according to an embodiment of the present disclosure.

FIG. 4 is a partial enlarged perspective view showing a cooling mechanism for a driving motor according to a first embodiment of the present disclosure.

FIG. 5 is a partial enlarged perspective view showing an oil path of the snap ring according to the first embodiment of the present disclosure.

FIG. 6 is a partial enlarged perspective view showing an oil supply path according to a second embodiment of the present disclosure.

FIG. 7 is a partial enlarged cross-sectional perspective view showing an oil path of the snap ring according to the second embodiment of the present disclosure.

FIG. 8 is a partial enlarged perspective view showing the oil flow path of the snap ring according to the second embodiment of the present disclosure.

FIG. 9 is a partial enlarged perspective view showing the snap ring and a stator according to the second embodiment of the present disclosure.

FIG. 10 is a partial enlarged cross-sectional perspective view showing an oil path of the snap ring according to a third embodiment of the present disclosure.

FIG. 11 is a partial enlarged perspective view showing the oil path of the snap ring according to the third embodiment of the present disclosure.

### DETAILED DESCRIPTION OF EMBODIMENTS

Hereinafter, an embodiment of the present disclosure is described in detail with reference to the accompanying drawings.

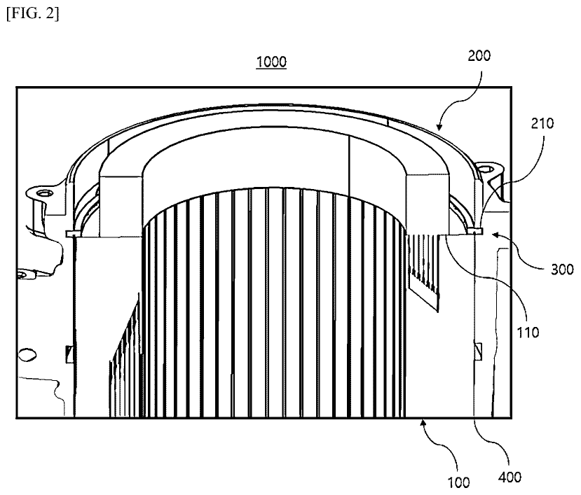

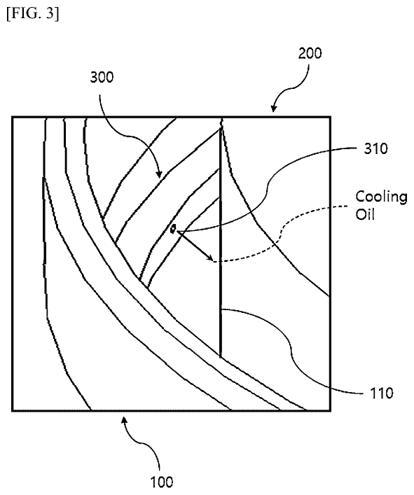

FIG. 2 shows a partial cross-sectional perspective view of a driving motor having a cooling mechanism for a driving motor according to an embodiment of the present disclosure. In addition, FIG. 3 shows a partial enlarged perspective view of a snap ring 300 according to an embodiment of the present disclosure.

As shown in the drawings, a cooling mechanism 1000 for a driving motor may include a cylindrical stator 100 wound with a coil, a cylindrical motor housing 200 accommodating the stator 100, the snap ring 300 fitted into an upper inner surface of the motor housing 200 to secure an upper side of the stator 100 accommodated in the motor housing 200, and an oil supply means for supplying oil to the snap ring 300, although not shown in the drawings. The oil supply means may be, for example, an oil pump for circulating the oil. Therefore, the oil pumped from the oil pump may flow through a gap between the stator 100 and the motor housing 200 along a path formed in the motor housing 200 and supply the oil to the snap ring 300.

The cylindrical motor housing 200 may have a sealed bottom and an open top.

The cylindrical stator 100 having a predetermined thickness may have the coil wound on an inner circumferential surface, and apply a current to the coil to thus rotate a rotor (not shown) disposed on an inner side of the stator 100.

The snap ring 300 may be formed in a shape of a ring having a predetermined width in a radial direction. The snap ring 300 may have a radial inner side protruding inward from an inner circumferential surface of the motor housing 200 as its radial outer circumference fitted into a snap ring securing groove 210 recessed radially outward from the inner circumferential surface of an upper side of the motor housing 200. In addition, the snap ring 300 may have a radially inner lower surface protruding and in contact with a circumference of an upper surface of the stator 100. Therefore, the stator 100 may be secured to the motor housing 200 by limiting an upward movement of the stator 100 while the stator 100 is seated on the motor housing 200.

Here, the snap ring 300 may include an oil spray path 310 formed therein to thus receive the oil supplied to an oil supply path 400 formed between an outer circumferential surface of the stator 100 and the inner circumferential surface of the motor housing 200 to spray the oil onto a coil end part 110 on the upper side of the stator 100.

The cooling mechanism 1000 having the above configuration is described in detail with reference to the drawings.

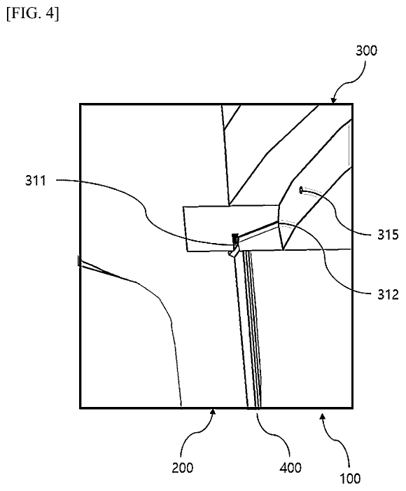

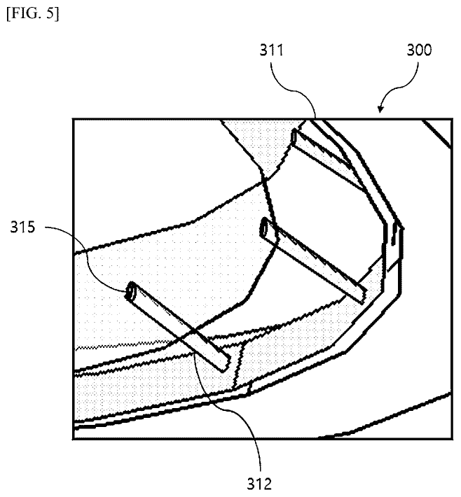

FIG. 4 shows a partial enlarged perspective view of the cooling mechanism 1000 for a driving motor according to a first embodiment of the present disclosure, and FIG. 5 shows a partial enlarged perspective view of the oil spray path 310 of the snap ring according to the first embodiment of the present disclosure.

As shown in the drawings, the oil supply path 400 may be formed between the inner circumferential surface of the motor housing 200 and the outer circumferential surface of the stator 100. The oil supply path 400 may have a predetermined width in a circumferential direction and be radially recessed inward from the outer circumferential surface of the stator 100. Although not shown in the drawings, in another embodiment, the oil supply path may be recessed radially outward from the inner circumferential surface of the motor housing 200.

Here, an upper end of the oil supply path 400 may be in contact with the lower surface of the snap ring 300, and the oil spray path 310 may include an inflow path 311 recessed circumferentially upward from the lower surface of the snap ring 300, and an outflow path 312 passing through the snap ring 300 radially inward from a downstream end of the inflow path 311, that is, the upper end. An upstream side of the inflow path 311 may communicate with the oil supply path 400, and distribute the oil supplied from the oil supply path 400 in the circumferential direction of the snap ring 300. The plurality of outflow paths 312 may be disposed to be spaced apart from each other in the circumferential direction of the snap ring 300, and may have a spray hole 315 formed in a downstream end to evenly spray the oil supplied through the inflow path 311 onto the coil end part 110 on the upper side of the stator 100.

The outflow paths 312 may be spaced apart from each other while having equal spacing, or may be disposed more densely in a region where relatively high heat occurs, if necessary.

With the above configuration, the oil may be sprayed evenly onto the coil end part 110 on the upper side of the stator 100, or intensively onto a specific region on the coil end part 110, by using only the snap ring 300 without any separate oil guide.

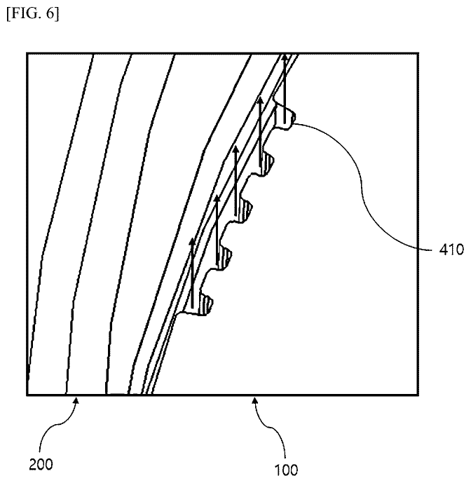

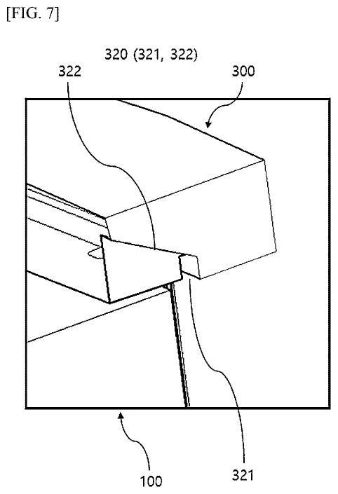

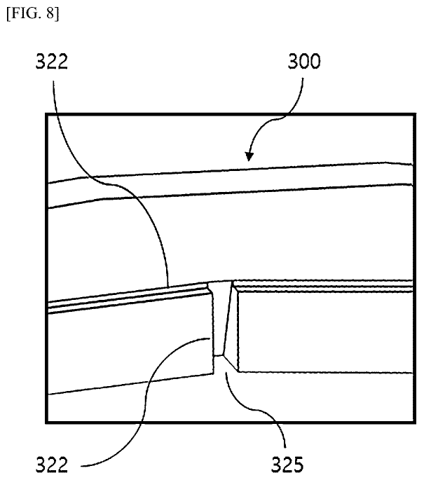

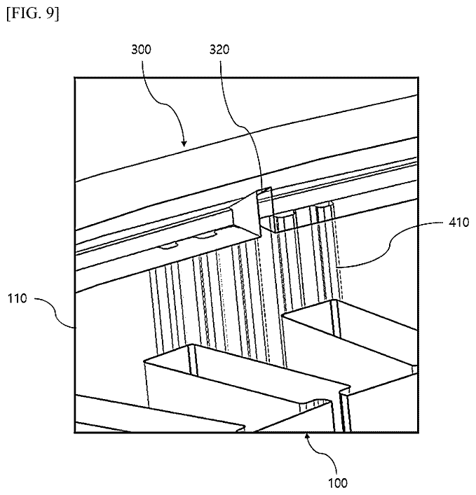

FIG. 6 shows a partial enlarged perspective view of an oil supply path 410 according to a second embodiment of the present disclosure. In addition, FIG. 7 shows a partial enlarged cross-sectional perspective view of an oil spray path 320 of the snap ring 300 according to the second embodiment of the present disclosure, and FIG. 8 shows a partial enlarged perspective view of the oil spray path 320 of the snap ring 300 according to the second embodiment of the present disclosure. In addition, FIG. 9 shows a partial enlarged perspective view of the stator 100 and the snap ring 300 according to the second embodiment of the present disclosure.

Referring to FIG. 6, the plurality of oil supply path 410 may be formed in a vertical longitudinal direction, recessed inward from the outer circumferential surface of the stator 100, and disposed to be spaced apart from each other in the circumferential direction. As shown in the drawings, the plurality of oil supply paths 410 may have narrower spacing, particularly in a region where a relatively large amount of heat occurs.

In addition, referring to FIGS. 7 to 9, the oil spray path 320 may include an inflow path 321 recessed circumferentially upward from the lower surface of the snap ring 300 and an outflow path 322 passing radially inward through the snap ring 300 from a downstream end of the inflow path 321, that is, the upper end. The outflow path 322 disposed on the densely disposed plurality of oil supply paths 410 may have the following configuration to increase a spray flow rate and a spray distance. The outflow path 322 may have an upstream end fluidically communicating with the inflow path 321, may have a predetermined width in the circumferential direction, and may be recessed upward from the lower surface of the snap ring 300. In particular, the outflow path 322 may have a longer recessed length toward its radial inner side, i.e., its downstream side. That is, the outflow path 322 may have an increased vertical width toward its downstream side. Therefore, a large amount of oil supplied from the oil supply path 410 may be smoothly sprayed as a spray hole 325 formed in a downstream end of the outflow path 322 has an increased area. In addition, the outflow path 322 may have the top sloping upward toward its downstream side to thus increase the spray distance.

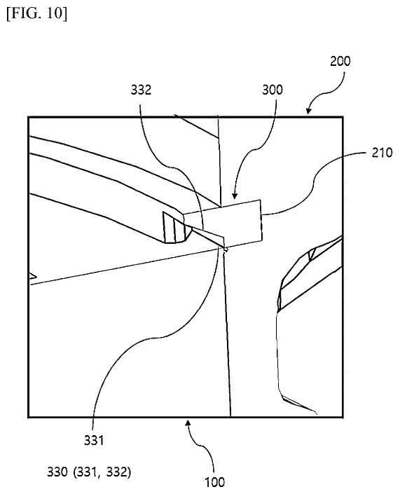

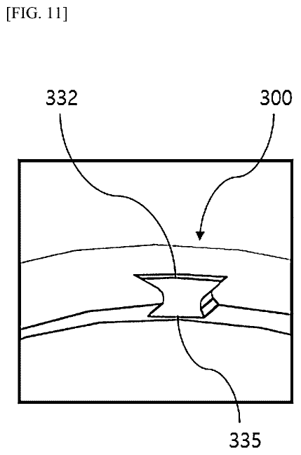

FIG. 10 shows a partial enlarged cross-sectional perspective view of an oil spray path 330 of the snap ring 300 according to a third embodiment of the present disclosure, and FIG. 11 shows a partial enlarged perspective view of the oil spray path 330 of the snap ring 300 according to the third embodiment of the present disclosure.

Meanwhile, the oil spray path 330 according to the second embodiment described above may have an oil flow rate reduced as the path has an increased cross-sectional area toward its downstream side. To solve this problem, the oil spray path 330 of the snap ring 300 according to the third embodiment may be configured as follows.

The oil spray path 330 may include an outflow path 332 fluidically communicating with the oil supply path 410. Here, the outflow path 332 disposed on the densely disposed plurality of oil supply paths 410 may have the following configuration to maintain an oil spray velocity while increasing the spray flow rate and the spray distance.

The outflow path 332 may be formed on the radial inner side of the snap ring 300 and recessed upward from the lower surface of the snap ring 300. In addition, the outflow path 332 may have a longer recessed length toward its radial inner side, i.e., its downstream side. In addition, the outflow path 322 may have a smaller circumferential width toward its downstream side. Therefore, the oil spray path 330 may directly receive the oil from the oil supply path 410 to the outflow path 332, and maintain a cross-sectional area of the outflow path 322 to thus maintain or increase the oil spray velocity. In addition, the outflow path 322 may have a width increased again near a spray hole 335 to thus increase an oil spray area.

The cooling mechanism for a driving motor according to the present disclosure configured as above may reduce the manufacturing cost or process cost for forming the cooling mechanism by spraying the cooling oil onto the stator using the snap ring for securing the stator to the motor housing without any separate configuration for spraying the oil onto the stator.

The cooling mechanism for a driving motor according to the present disclosure may be applied to the motors having various specifications that require intensive cooling at a specific location at a low cost, as the spray location of the cooling oil or a supply flow rate may be easily adjusted by modifying a design of the snap ring.

The spirit of the present disclosure should not be limited to an embodiment described above. The present disclosure may be applied to various fields and may be variously modified by those skilled in the art without departing from the scope of the present disclosure claimed in the claims. Therefore, it is obvious to those skilled in the art that these alterations and modifications fall within the scope of the present disclosure.

What is claimed is:

1. A cooling mechanism for a driving motor, the mechanism comprising:
a cylindrical stator wound with a coil and including a first side and a second side;
a cylindrical motor housing having a first side sealed, a second side open, and accommodating the stator therein;
a snap ring fitted into an inner circumferential surface of the second side of the motor housing to have a radial inner side protruding inward from the inner circumferential surface of the motor housing, and securing the second side of the stator by having a surface protruding and in contact with a circumference of a surface of the stator; and
an oil supply path formed between an outer circumferential surface of the stator and the inner circumferential surface of the motor housing to supply oil to the snap ring through the oil supply path,
wherein the snap ring includes an oil spray path having an upstream side fluidically communicating with the oil supply path and a downstream side passing through an inner circumferential surface of the snap ring and exposed to the second side of the stator.

2. The mechanism of claim 1, wherein the oil supply path is formed in an axial direction of the stator, has a predetermined width in a circumferential direction of the stator, and is recessed radially inward from the outer circumferential surface of the stator.

3. The mechanism of claim 1, wherein the oil supply path is formed in an axial direction of the stator, has a predetermined width in a circumferential direction of the stator, and is recessed radially outward from the inner circumferential surface of the motor housing.

4. The mechanism of claim 1, wherein the oil spray path includes
an inflow path recessed circumferentially upward from a lower surface of the snap ring and include first and second ends,
an outflow path passing through the snap ring radially inward from the second end of the inflow path, and
a spray hole formed in a downstream end of the outflow path.

5. The mechanism of claim 4, wherein the inflow path is formed in a closed curve in a circumferential direction of the stator.

6. The mechanism of claim 4,
wherein the inflow path is in plural, and
wherein the plurality of inflow paths each have a predetermined width in the circumferential direction and are disposed to be spaced apart from each other in the circumferential direction.

7. The mechanism of claim 4,
wherein the outflow path is in plural, and
wherein the plurality of outflow paths have equal spacing in a circumferential direction of the stator or have variable spacing based on a region of the stator, where heat occurs.

8. The mechanism of claim 4, wherein the outflow path has an upstream end fluidically communicating with the inflow path, has a predetermined width in a circumferential direction of the stator, and is recessed upward from the lower surface of the snap ring.

9. The mechanism of claim 8, wherein the outflow path has a longer recessed length toward a radial inner side of the snap ring.

10. The mechanism of claim 9, wherein the outflow path has a smaller circumferential width toward a radial inner side of the snap ring.

11. The mechanism of claim 9, wherein the outflow path includes a width increased near the spray hole.

12. The mechanism of claim 1, wherein the oil spray path includes:
an outflow path recessed upward from a radially inner lower surface of the snap ring, and
a spray hole formed in a radially inner end of the outflow path.

13. The mechanism of claim 12, wherein the oil spray path includes a sloping upward toward a downstream side thereof to thus increase spray distance.

14. The mechanism of claim 12,
wherein the outflow path is in plural, and
wherein the plurality of outflow paths have equal spacing in a circumferential direction of the stator or have variable spacing based on a region of the stator, where heat occurs.
